(19) United States
(12) Patent Application Publication
(10) Pub. No.: US 2024/0052091 A1
(43) Pub. Date: Feb. 15, 2024

(54) POLYURETHANE COMPOSITIONS HAVING IMPROVED FORCE RETENTION AND MOISTURE RESISTANCE

(71) Applicant: Bay Materials, LLC, Fremont, CA (US)

(72) Inventors: Ray F. Stewart, Fremont, CA (US); John Lahlouh, Fremont, CA (US); Diyun Huang, Fremont, CA (US)

(21) Appl. No.: 18/487,896

(22) Filed: Oct. 16, 2023

Related U.S. Application Data
(63) Continuation of application No. PCT/US2022/025306, filed on Apr. 19, 2022.
(60) Provisional application No. 63/176,439, filed on Apr. 19, 2021.

(51) Int. Cl. C08G 18/76; C08G 18/32; C08G 18/42; C08G 18/36; C08G 18/66; C08G 18/48; C08J 5/18

(52) U.S. Cl. CPC C08G 18/7671; C08G 18/3206; C08G 18/4277; C08G 18/36; C08G 18/3212; C08G 18/664; C08G 18/4854; C08G 18/6674; C08J 5/18; C08J 2375/08

(57) ABSTRACT

Improved thermoplastic polyurethane compositions include a diol component and a diisocyanate component wherein the diol component comprises at least one linear aliphatic diol having the general formulas HO—(CH2)x-OH wherein x is an integer from 9 to 18 and one or more cyclic diols having 6 or more carbons, or one or more aromatic diols, wherein the molar ratio of isocyanate groups to alcohols (NCO Ratio) is from about 0.95 to 1.05, and the reaction mixture comprises less than 20% of a polymeric diol component having a glass transition temperature of less than 0° C. The TPU compositions exhibit a combination of moderate elastic modulus, high elongation to yield, high elongation to break, high optical clarity, good stain resistance, good elastic recovery, and excellent force retention in the presence of water at moderate temperatures.

### RELATED APPLICATIONS

This application is a continuation of International Patent Appl. No. PCT/US2022/025306 filed on Apr. 19, 2022, which claims priority to and claims the benefit of U.S. Provisional Patent Application 63/176,439 filed on Apr. 19, 2021, titled “POLYURETHANE COMPOSITIONS HAVING IMPROVED FORCE RETENTION AND MOISTURE RESISTANCE,” the entire contents of both of which are incorporated by reference.

### TECHNICAL FIELD

The present disclosure relates to improved thermoplastic polyurethane compositions useful for producing medical appliances that exhibit a combination of moderate elastic modulus, high elongation to yield, high elongation to break, high optical clarity, good stain resistance, good elastic recovery, and excellent stress retention in the presence of water at moderate temperatures.

### BACKGROUND

There exists a large body of literature regarding polyurethane chemistry, properties, and preparation, including a number of patents, published patent applications, and books including, Szycher's Handbook of Polyurethanes, Michael Szycher (Editor) CRC Press, July 2012, and Polyurethane Handbook, Gunter Oertel (Editor) Hanser Pub Inc., January 1994. The compositions disclosed herein differ from prior art polyurethanes in numerous ways, as detailed hereinbelow.

U.S. Pat. No. 4,376,835 discloses polyurethanes having high modulus and high heat distortion temperature prepared by polymerization of 2 to 25% of a polyol having a glass transition temperature of less than 20° C. and a molecular weight of from 500 to 20,000 daltons and one or more low molecular weight chain extenders, with butane diol, hexane diol, neopentyl glycol and cyclohexanedimethanol (CHDM) preferred. In contrast, the polyurethane compositions described herein are not prepared by polymerization of polyols and low molecular weight chain extenders.

U.S. Pat. No. 4,822,2827 discloses polyurethanes comprising a polyisocyanate component and a polyol component comprising a mixture of one or more cycloalkylene diol or biscycloalkane diols and at least one other chain extender which has 2 to 10 carbon atoms. The materials may additionally comprise up to 25% of a polymeric polyol having a molecular weight of greater than 500. The described materials have a high flexural modulus (greater than about 260,000 PSI), glass transition temperatures of at least 125° C. and are relatively brittle, having an elongation at break of less than about 35%. These materials are reported to be useful in applications requiring resistance to high temperatures. In contrast, the polyurethane compositions described herein are not prepared with a combination of a polyisocyanate component, polymeric polyols, and cycloalkylene diol or biscycloalkane diol chain extenders having a Tg of greater than 125° C.

US 20180127535 discloses two phase polyurethane elastomers with a shore D hardness of more than 50 comprised of about 26 to 40% polycaprolactone based soft blocks and hard blocks comprised of a polyisocyanate and a long chain diol chain extender. The chain extender may be a linear aliphatic diol with 9 to 16 carbons. Due to the biphasic nature of the materials the compositions have haze values of around 30. The thermoplastic polyurethane (TPU) compositions disclosed herein have a haze value of less than 20, and do not include soft blocks with 26 to 40% polycaprolactone.

WO 2014/210099 (US 20160122462) discloses two phase polyurethane elastomers with a shore D hardness of less than 60 and good rebound properties comprised of about 23 to 55% polycaprolactone based soft blocks and hard blocks comprised of a polyisocyanate and a long chain diol chain extender. The chain extender may be a linear aliphatic diol with 9 to 16 carbons. Due to the biphasic nature of the materials the compositions have haze values of around 30. The TPU compositions disclosed herein have a haze value of less than 20, and do not include soft blocks with 26 to 40% polycaprolactone.

US2016311964A1 discloses polyurethanes having high resilience prepared from polyether polyols, linear aliphatic diisocyanates and linear chain extenders having crystalline melting points of less than 180 C. The TPU compositions disclosed herein are substantially amorphous and exhibit little to no crystallinity.

US20180319925A1 discloses high modulus polyurethane comprised of 5-25% by weight of a polyol, an aromatic diisocyanate and linear diols. 1,3-propanediol, 1,4-butanediol, 1,6-hexandiol, 1,3-butanediol, 1,5-pentanediol, 1,9-nonanediol, 1,12-dodecanediol, ethylene glycol, 1,4-benzenedimethylol benzene glycol, and 1,4-cyclohexanedimethanol are described as useful chain extenders, and if the chain extender is an unbranched, unsubstituted, linear chain glycol having 2 to 12 carbon atoms, for example about 2 to 9 carbon atoms, the thermoplastic polyurethane may be crystalline. The disclosed TPU compositions are prepared by reaction of a polyisocyanate component, a diol component comprised of long chain diols having the general structure HO-(CH 2),-OH where n equals 9 to 18; and at least a second cyclic diol having six or more carbon atoms and do not include 5-25% by weight of a polyol or chain extenders.

WO 2020/225651 discloses polyurethanes useful for orthodontic applications prepared by reacting a hydrogenated fatty dimer acid (diol) having 36 carbon atoms with a diisocyanate such as MDI and a short chain diol such as hexanediol to produce a polyurethane having hard and soft domains. Hydrogenated fatty dimer acid (diol) having 36 carbon atoms and short chain diols such as hexanediol are not included in the polyurethane reaction mixtures disclosed herein.

US 2012/0329883 A1 discloses water swellable polyurethanes prepared by polymerizing polyethylene glycols and or polypropylene glycols with diisocyanates and chain extenders to produce multiphase thermoplastic materials. Hexane diol, decane diol and dodecane diol are said to be preferred chain extenders. Samples tested have high water uptake with water uptakes of greater than 2% up to as much as 40%., The disclosed polyurethane compositions in contrast have low equilibrium water uptake.

US 2015/0368392 A1 discloses shore A TPUs prepared from dimer acid based diols (soft block material) combined with a diol chain extender mixture of a linear C12 diol and branched diols wherein the branched diol is from 15 to 30% of the total diols. The materials are claimed be both clear and hydrophobic, however, use of higher amounts of branched diols resulted in undesirable sticky materials. Neither dimer acid based diols (soft block material), nor branched diols chain extenders are included in the polyurethane reaction mixtures disclosed herein.

There remains a need for TPU compositions which exhibit high elongation to yield, high elongation to break, high optical clarity, good stain resistance and excellent stress retention in the presence of water at moderate temperatures. The current disclosure addresses this need.

### SUMMARY

The disclosure provides thermoplastic polyurethane (TPU) reaction mixtures which comprise a diol component and a diisocyanate component wherein the diol component comprises at least one linear aliphatic diol having the general formulas HO—(CH₂)ₓ—OH wherein x is an integer from 9 to 18 and one or more cyclic diols having 6 or more carbons. The molar ratio of isocyanate groups to alcohol groups (NCO Ratio) is from about 0.95 to 1.05, and the reaction mixture comprises less than 20% of a polymeric diol component having a glass transition temperature of less than 0° C.

The diisocyanate component of the TPU reaction mixture may comprise one or more of MDI, TDI, PDI, HDI, H12MDI, IPDI, XDI, CHDI, or HXDI and the diisocyanate component of the TPU reaction mixture may comprise greater than 50%, 55%, 60%, 65%, 70%, 75%, 80%, 85%, or 88% MDI or H12MDI.

The diol component of the TPU reaction mixture may comprise greater than 80 mole percent of cyclohexane dimethanol, 4,4′-isopropylidenedicyclohexanol and linear or branched diols having 9 or more carbon atoms.

The TPU reaction mixture may comprise an aliphatic diol component including one or more of 1,9-nonanediol, 1,10-decanediol, 1,11-undecanediol, 1,12-dodecanediol, 1,14-tetradecanediol, 1,16-hexadecanediol, 1,18-octadecanediol, and dimer alcohols.

The TPU reaction mixture may comprise a cyclic diol component which includes one or more of cyclohexane dimethanol, tetramethylcyclobutanediol, hydrogenated bisphenol A, cyclohexane diol, and isosorbide.

The TPU reaction mixture may comprise an aromatic diol component including one or more of 1,2-benzenedimethanol, 1,3-benzenedimethanol, 1,4-benzenedimethanol, 1,4-bis(2-hydroxyisopropyl)benzene, 1,4-bis(2-hydroxyethyl)benzene, 2,2′-(o-phenylenedioxy)diethanol, resorcinol bis(2-hydroxyethyl) ether, hydroquinone bis(2-hydroxyethyl) ether, and bis(2-hydroxyethyl) terephthalate.

The disclosure further provides TPU compositions prepared with a reaction mixture described herein where the TPU (polymer) is characterized by one or more of: (a) being substantially amorphous with a glass transition temperature of greater than 85° C.; (b) being substantially amorphous with a glass transition temperature of greater than 100° C. or greater than 110° C.; (c) having a stress retention of greater than 500 grams or greater than 750 grams; (d) having a water uptake of less than 1.80% after 48 hours at 60° C.; (e) having an elongation at yield of greater than 7% or 8%; (f) having an elongation at break of greater than 55% or greater than 75%; (g) having a dB staining value of less than 10, or less than 3; (h) having a flexural modulus of from 500 Mpa to 2,500 Mpa; (i) having a haze value of less than 10, or less than 6; or (j) having a higher TG and substantially no increase in water uptake relative to a thermoplastic polyurethane composition which includes an aliphatic diol and lacks a cyclic diol.

The disclosure further provides TPU compositions prepared with a reaction mixture described herein wherein when thermoformed the TPU (polymer) exhibits a force retention of greater than 800 g when a 0.76 mm thick sample is tested at 37° C. for 24 hours with a strain of 5%.

The disclosure further provides polymeric sheet compositions and laminates comprising a TPU composition as disclosed herein.

Reversibly deformable dental appliances conformal to one or more teeth comprising a polymeric sheet composition or laminate disclosed herein are further provided.

### BRIEF DESCRIPTION OF THE DRAWINGS

FIG. 1 is a graphic depiction of the relationship between water uptake and shape recovery for exemplary TPU compositions.

FIG. 2 is a graphic depiction of the shape recovery as a function of glass transition temperature of exemplary TPU compositions.

FIG. 3 is graphic depiction of force retention as a function of water uptake for exemplary TPU compositions.

### DETAILED DESCRIPTION

Various preferred features and embodiments will be described below by way of non-limiting illustration.

Polyurethanes are used in numerous applications including the production of films, sheet, tubing, molded parts, and coatings. They may range in hardness from very soft, for example less than Shore A 35 to rigid, for example Shore D 85 or higher. They may be used alone or as blends, or alloys and may be combined for example with fillers or additives including flame retardants, glass fibers, waxes, or process aids. They may be used as part of a multilayer structure formed by lamination of discreet layers, or sequential or coextrusion.

When used in medical applications, for example to produce dental or orthodontic appliances they should be biocompatible, stain resistant to materials like coffee, wine, and mustard, and have low compression set and/or stress relaxation, especially when exposed to body temperature and fluids such as saliva, mucus or blood. Excellent optical properties including high light transmission and low haze are desirable. In some applications, such as dental aligners, materials should have good chemical resistance, in particular resistance to stress cracking and good abrasion resistance. Ideally, the materials are not degraded by alcohol, surfactants, mildly acidic or basic compositions, including dental care products or lipids found for example in fingerprints or olive oil.

Polyurethanes may be crosslinked thermosets or may be thermoplastic and may be processed for example by casting, extrusion, molding, thermoforming or 3D printing. Polyurethanes are typically produced by reaction of one or more polyisocyanates and one or more diols and or polyols which creates repeating urethane groups. Polyurethanes can include hard and soft microdomains, which are chemically bonded together by the urethane links. By combining hard and soft regions, some TPUs provide improved strength and toughness, while remaining flexible. Other polyurethanes may be comprised of essentially all hard blocks having a glass transition or melting point above room temperature, for example greater than 60° C. to about 240° C. While these materials are not considered elastomers, they may contain minor amounts of soft blocks derived from polyols, polyamines or polythiols to improve certain properties.

Some polyurethanes may additionally contain amide or urea linkages resulting from reaction with amines or water, and are referred to as polyurethane ureas.

Due to their desirable properties and excellent biocompatibility polyurethanes are a material of choice for producing dental appliances including but not limited to aligners, retainers, bite guards, splits, and sports mouth guards. The polyurethanes can be formed into appliances by any known method including thermoforming, molding, 3D printing or casting and may be the entire material or may be part of a layered structure comprised of two or more materials.

The technology described herein provides TPU compositions having superior mechanical and optical properties with improved stain resistance, low water absorption and improved stress retention and can be prepared by conventional processes using specific polyisocyanates and diols in a one-step (batch) or multistep process. These polyurethanes are prepared by reaction of (a) a polyisocyanate component, (b) a diol component comprised of long chain diols having the general structure HO—(CH₂)ₓ-OH where x equals 9 to 18; and at least a second cyclic diol having six or more carbon atoms; and (c) optionally a minor component of a polyol having a molecular weight of 650 to 5,000.

The resulting polyurethanes are substantially amorphous, have a glass transition temperature of greater than about 85° C., exhibit a favorable combination of mechanical, optical, and thermal properties, and have unusually low moisture uptake which is believed to improve force retention in the presence of water and facilitates drying and thermoforming. The disclosed polyurethanes have particular utility in the production of orthodontic aligners where low stress relaxation in the presence of water at moderate temperatures is required combined with ease of thermoformability, stain resistance and excellent clarity.

### Definitions

Unless defined otherwise, all technical and scientific terms used herein have the same meaning as commonly understood by one of ordinary skill in the art. Although other methods and materials similar, or equivalent, to those described herein can be used in the practice of the present disclosure, the preferred materials and methods are described herein. Other features and advantages of the disclosure will be apparent from the following detailed description, and from the claims.

The term “aliphatic diol” is used herein with reference to organic compounds in which the carbon atoms are connected by single, double, or triple bonds to form nonaromatic structures which may be linear, branched or cyclic and contain two hydroxyl (OH) groups

The term “ASTM D638”, is used herein with reference to the test for plastics tensile strength. This test is used to evaluate elongation to yield and break, tensile modulus, and Poisson's ratio. Unless specified otherwise samples were tested using type IV tensile bar and a speed of 1.27 cm/min.

The term “ASTM D1364”, is used herein with reference to the test for inter layer peel strength.

The term “branched aliphatic diol” is used herein with reference to diols having one or more branches in the carbon chain, for example neopentyl glycol and 2-butyl-2-ethylpropanediol.

As used herein, the term “compression set” refers to the permanent deformation of a material when a force is applied and removed. Unless specified otherwise, compression set is measured according to ASTM D 395-B at specified time and temperature, for example 22 hours at 23° C.

The term “comprises”, and grammatical equivalents thereof are used herein to mean that, in addition to the features specifically identified, other features are optionally present. For example, a composition or device “comprising” (or “which comprises”) components A, B and C can contain components A, B and C, or can contain components A, B and C but also one or more other components.

The terms “consisting essentially of” and grammatical equivalents thereof are used herein to mean that, in addition to the features specifically identified, other features may be present which do not materially alter the claimed compositions.

The term “at least” followed by a number is used herein to denote the start of a range beginning with that number (which may be a range having an upper limit or no upper limit, depending on the variable being defined).

The term “at most” followed by a number is used herein to denote the end of a range ending with that number (which may be a range having 1 or 0 as its lower limit, or a range having no lower limit, depending upon the variable being defined). When a range is given as “(a first number) to (a second number)” or “(a first number)-(a second number)”, this means a range whose lower limit is the first number and whose upper limit is the second number.

The term “cyclic diol” is used herein with reference to diols having a ring structure, for example 1,4-cyclohexanedimethanol, 1,2-cyclohexanediol, 1,4-cyclohexanediol or isosorbide. Cyclic diols may contain more than one ring structure.

The term “staining dB value” or “dB value” refers to staining of a sample by mustard as detailed below.

The term “initial color in dB” refers to the color of a sample measured before staining as detailed below.

As used herein with reference to the disclosure, the term “dimer alcohol” means a diol derived from hydrogenation of a dimer acid, typically having 36 carbon atoms.

As used herein, the terms “dynamic mechanical analysis”, and “DMA” refer to a test used to evaluate thermal and mechanical properties of a material including the loss and storage modulus. The DMA testing is conducted on an instrument capable of applying a cyclical stress or strain on a material and measuring its response to specific conditions, as detailed below.

As used herein, the term “elongation at break” refers to the percentage increase in length that a material will achieve before breaking. The test method employed herein is ASTM D638 unless specified otherwise.

As used herein, the terms “elongation at yield” and “yield elongation” refer to the ability of a plastic specimen to resist changes of shape before it deforms irreversibly. The elongation at yield is the ratio between increased length and initial length at the yield point. The test method employed herein is ASTM D638.

As used herein, the terms “embodiment”, “one embodiment”, and “some embodiments”, refer to a particular feature, structure or characteristic described in connection with the present disclosure. Thus, the use of the terms “in one embodiment”, “in an embodiment”, or “in some embodiments”, in various places throughout the specification do not necessarily refer to the same embodiment. Certain features of the disclosure, described in the context of separate embodiments, may also be provided in combination in a single embodiment. Conversely, features of the disclosure, which are, described in the context of a single embodiment, may also be provided separately or in one or more sub-combinations.

As used herein, the term “dental appliance” refers to any device intended to be placed in the oral cavity or on the teeth of a subject. Dental appliances include but are not limited to orthodontic, prosthetic, retaining, snoring/airway, cosmetic, therapeutic, protective (e.g., mouth guards) and habit-modification devices.

The terms “equilibrium moisture uptake”, “water uptake”, and “moisture uptake” are used interchangeably herein with reference to the percentage by weight of water uptake by a sample that is first dried at 100° C. in a vacuum oven for 8 hours or longer, and then placed in water at 60° C. for 48 hours.

As used herein, the term “flexural modulus” refers to the rigidity of a material and/or resistance of the material to deformation in bending. The higher the flexural modulus of the material, the more resistant to bending it is. Unless stated otherwise, flexural modulus is measured according to ASTM D790 and is reported as megapascals (MPa) or as pounds (force) per square inch (psi).

As used herein, the term “glass transition temperature” refers to the gradual and reversible transition in amorphous and semicrystalline materials from a “glassy” state into a viscous or rubbery state as the temperature is increased, as detailed below.

As used herein, the term “hardness” refers to a Shore hardness scale, and unless otherwise stated is measured according to ASTM D 2240. A durometer measures the penetration of a metal foot or pin into the surface of a material. There are different durometer scales, but Shore A and Shore D are commonly used. Materials with higher durometer values will be harder compared to materials with a lower durometer value. Shore hardness and modulus are generally correlated and can be converted by approximation if only one value is known by methods described in the art.

As used herein, the terms “haze”, and “haze value” are an indicator of clarity that is measured by ASTM D1003, as further detailed below.

As used herein, the term “modulus,” “Young's modulus”, and “elastic modulus” refer to the rigidity of a material and/or resistance of the material to stretching. The higher the modulus of the material, the more rigid. The flexural modulus and elastic modulus of a material may be the same or different. For isotropic materials, flexural modulus, and modulus (which may also be referred to as elastic modulus) are substantially the same and one or the other may be measured dependent upon the circumstances. For polymers, the mechanical properties including elastic modulus and other properties may be measured as proscribed by ASTM D 638. Unless designated otherwise, “modulus” refers to elastic modulus. For an isotropic material, the elastic modulus measured in any direction is the same. For non-isotropic materials such as laminates tensile modulus and flexural modulus may be measured and reported independently.

As used herein, the terms “plural”, “multiple”, “plurality” and “multiplicity” denote two or more than two features.

The term “polymeric diol” is used herein with reference to polymeric materials having two alcohol functional groups per molecule, such as polyethylene glycol.

The term “polyol” is used herein with reference to polymeric materials having two or more alcohol groups per molecule such a polytetramethylene glycol or derivatives having an average of two or more alcohol functional groups per molecule.

As used herein, the term “polymeric sheet” is used interchangeably with the term “plastic sheet”.

As used herein, the term “shape recovery” refers to the ability of a polymer to recover it shape after 24 hours at 37° C. in deionized water at 5% strain. The Shape Recovery test is used to measure the percentage of original polymer shape recovered, after 24 hours under 5% strain in 37° C. DI water. A polymer strip measuring 101.75×25.4×0.76mm (L, w, t) is wrapped around a PVC pipe (48.25 mm diameter), clamped at the two ends, and immersed in 37° C. DI water for 24 hours. At the end of the test period, the clamps are removed, and the strip allowed to recover freely for 24 hours in air. The 24-hour shape recovery (%) is determined according to the following equation:

24 hour shape recovery (%)=100×(1−(((L−L24)/(L−L0))), where
L=full length of strip, 101.75 mm
L0=distance between opposite ends of clamped strip, 43.5 mm
L24 =distance (mm) between opposite ends of free strip after 24 hour recovery.

As used herein, the terms “force retention” and “stress retention”, refer to the force [pound-force (lbf), gram-force (gf), etc.] required to maintain a specified constant strain.,

As used herein, the term “thermoplastic polymer” refers to a polymer that becomes pliable or moldable above a specific temperature and solidifies upon cooling, provided that the heat and pressure do not chemically decompose the polymer.

This specification incorporates by reference all documents referred to herein and all documents filed concurrently with this specification or filed previously in connection with this application, including but not limited to such documents which are open to public inspection with this specification. The TPU compositions disclosed herein are prepared by reaction of a mixture of two or more components. Reference to a reaction mixture for making a polyurethane composition may also be used to refer to a polymer derived from the reaction mixture.

### Polymer Components

Polyisocyanate Component. The TPU compositions described herein may be made using one or more polyisocyanates. In some embodiments, the polyisocyanate component includes one or more of aromatic diisocyanates, such as phenylene diisocyanates, aliphatic diisocyanates, cyclo aliphatic diisocyanates, and combinations thereof.

In some embodiments, the polyisocyanate component of the reaction mixture includes one or more aromatic diisocyanates, including but not limited to 4,4′-methylenebis(phenyl isocyanate) (MDI), m-xylylene diisocyanate (XDI), phenylene-1,4-diisocyanate, 3,3′-Dimethyl-4,4′-biphenylene diisocyanate (TODI), 1,5-naphthalene diisocyanate (NDI), and toluene diisocyanate (TDI), and modifications of any of the above.

In some embodiments, the TPU composition is prepared using a polyisocyanate component that includes MDI.

In some embodiments, the polyisocyanate component of the reaction mixture includes one or more aliphatic diisocyanates such as isophorone diisocyanate (IPDI), 1,4-cyclohexane diisocyanate (CHDI), 1,3-bis(isocyanatomethyl)cyclohexane (HXDI), decane-1,10-diisocyanate, lysine diisocyanate (LDI), 1,4-butane diisocyanate (BDI), isophorone diisocyanate (IPDI), and dicyclohexylmethane-4,4′-diisocyanate (H12MDI).

In some embodiments, the TPU composition is prepared using a polyisocyanate component that includes H12MDI.

In some embodiments, the polyisocyanate component is essentially free of, or even completely free of, aliphatic diisocyanates.

In some embodiments, the polyisocyanate component is essentially free of, or even completely free of, aromatic diisocyanates.

In some embodiments, the polyisocyanate component includes one or more cycloaliphatic isocyanates.

In some embodiments, the reaction mixtures described herein may include a small amount (less than 5% by weight) of polyester diols derived from caprolactone monomers.

Diol Component

In some embodiments, the diol component of the reaction mixture includes at least one linear aliphatic diol having the general formulas HO—(CH₂)ₓ-OH wherein x is an integer from 9 to 36, from 9 to 30, from 9 to 24, or from 9 to 18. Examples include, 1,9-nonanediol, 1,10-decanediol, 1,11-undecanediol, 1,12-dodecanediol, 1,14-dodecanediol, 1,16-hexadecanediol, 1,18-octadecanediol, diols derived from polyalpha olefins and hydrogenated butadiene polyols, and a combination thereof.

In some embodiments, the diol component includes at least one branched aliphatic diol, for example 2-butyl-2-ethyl-1,3-propanediol or neopentyl glycol.

In some embodiments, the diol component of the reaction mixture includes at least one aromatic diol having benene or other aromatic rings, such as 1,2-benzenedimethanol, 1,3-benzenedimethanol, 1,4-benzenedimethanol, 1,4-bis(2-hydroxyisopropyl)benzene, 1,4-bis(2-hydroxyethyl)benzene, 2,2′-(o-phenylenedioxy)diethanol, resorcinol bis(2-hydroxyethyl) ether, hydroquinone bis(2-hydroxyethyl) ether, and bis(2-hydroxyethyl) terephthalate.

In some embodiments, the diol component of the reaction mixture includes one or more cyclic diols having six or more carbon atoms, such as a cyclo aliphatic diol, or a diol comprising one or more of oxygen, nitrogen, sulfur or phosphorous atoms for example, 1,3 or 1,4-cyclohexanedimethanol (CHDM), 1,2, 1,4 or 1,3-cyclohexane diol, 2,2,4,4-tetramethyl-1,3-cyclobutanediol (TMCBD), 4,4′-isopropylidenedicyclohexanol, isosorbide, isomannide, and 3,9-Bis(1,1-dimethyl-2-hydroxyethyl)-2,4,8,10-tetraoxaspiro[5.5]undecane (spiroglycol), [8-(hydroxymethyl)-3-tricyclo[5.2.1.02,6]decanyl]methanol, 1,1′-isopropylidine-bis[(p-phenylene-oxy)-2-ethanol], dimer acid based diols, hydroquinone bis(2-hydroxyethyl) ether, resorcinol bis(2-hydoxyethyl) ether.

In some embodiments the reaction mixture includes 1,3-propanediol, 2-ethyl-2[6,8,8-trimethyl-6-[(trimethylsily)oxy]-2,7-diosa-6,8-disilanon-1-yl] (Silmer OHT A0). In some embodiments the reaction mixture contains 0.5 to 5, 1 to 10, 2-20 mole % of Silmer OHT A0.

In some embodiments, the reaction mixture includes additional diols in minor amounts.

In some embodiments, the reaction mixture includes a cyclic ether diol.

In some embodiments, the reaction mixture includes an aromatic diol, for example 2,2-bis[4-(2-hydroxyethoxy)phenyl]propane (HEPP), hydroxyethyl resorcinol (HER), or a combination thereof.

In some embodiments, the reaction mixture includes a polyamine.

In some embodiments, the reaction mixture includes a polyol having a molecular weight of 500 to 5,000.

In some embodiments, the polyol component of the reaction mixture includes a triol or tetrol.

In some embodiments, the reaction mixture includes a polyether polyol.

In some embodiments, the reaction mixture includes a polyester polyol.

In some embodiments, the reaction mixture includes polysiloxane polyol

In some embodiments, the reaction mixture includes polybutadiene (PBD) based polyol

In some embodiments, the reaction mixture includes a multifunctional polyol having an average of more than 2 hydroxyl groups.

In addition to these recited polyols the reaction may include a small amount (<5%) of relatively small polyhydroxy compounds, for example aliphatic or short chain glycols having from 2 to 20, 2 to 12, or 2 to 10 carbon atoms. Examples include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, hexamethylenediol, heptanediol, nonanediol, dodecanediol, and mixtures thereof.

In some embodiments the reaction mixture includes multifunctional branching molecules having greater than two reactive groups per molecule selected from isocyanate, hydroxyl, amine and thiol groups.

Exemplary branching molecules include tris(2-hydroxyethyl) isocyanurate, glycerine, trimethylolpropane, 1,3,5-tris(hydroxymethyl)benzene, pentaerythritol, diethanol amine, triethanol amine and their ethoxylates or propoxylates. Additional branching agents include tri or higher functional isocyanates including poly isocyanates such as the trimer of hexane diisocyanate or MDI or IPDI.

In some embodiments the average combined functionality of the isocyanates, diols and polyols is greater than 2.0, 2.01, 2.02, 0.03, 2.04, 2.05.

In some embodiments, the reaction mixture includes additives or catalysts. Examples of urethane catalysts include tertiary amines such 1,4-diazabicyclo[2.2.2.]octane (DABCO), N-methylmorpholine, N-ethylmorpholine, tin compounds such tin(II)laurate, dibutyltin dilaurate, tin mercaptides, bismuth carboxylates and iron III compounds and combinations thereof.

In some embodiments, the reaction mixture may include one or more of UV stabilizers, UV absorbers, antioxidant stabilizers (for example phenolics, phosphites, thioesters, and/or amines, light stabilizers, heat stabilizers, waxes, lubricants, pigments and dyes.

All of the additives described herein may be used in a reaction mixture in an effective amount known to those of skill in the art for use of each substance.

In some embodiments, the TPU compositions described herein may also be blended with one or more other polymers.

In some embodiments, the reaction mixture comprises less than 10 mole percent of aliphatic diols having less than 9, 8, 7, 6, 5, 4, or 3 carbon atoms.

In some embodiments, the reaction mixture comprises less than 20%, 10%, 5%, 2.5% w/w of a polymeric diol.

In some embodiments, the diisocyanate component of the reaction mixture comprises greater than 50%, 60%, 70%, 80%, 85%, or 88% MDI.

In some embodiments, the diisocyanate component of the reaction mixture comprises greater than 50%, 60%, 70%, 80%, 85%, or 88% H12MDI.

In some embodiments, the reaction mixture comprises a polymeric diol having a glass transition temperature less than 0° C.

In some embodiments, the reaction mixture comprises a polypropylene oxide-based diol, triol or tetrol.

In some embodiments, the reaction mixture comprises a polymeric diol having a molecular weight of greater than 500.

In some embodiments, the TPU composition is comprised of a polyisocyanate component selected from 2,4′ MDI, 4,4′ MDI, blends of 2,4′ MDI and 4,4′ MDI, modified MDI, 2,4′ H12MDI, 4,4′ H12MDI, blends of 2,4′ H12MDI and 4,4′ H12MDI, or modified H12MDI, one or more linear aliphatic diols, HO—(CH₂)ₓ-OH, wherein x =from 8 to 18, e.g., 8, 9, 10, 11, 12, 13, 14, 15, 16, 17, or 18, aromatic diols, 1,2-benzenedimethanol, 1,3-benzenedimethanol, 1,4-benzenedimethanol, 1,4-bis(2-hydroxyisopropyl)benzene, 1,4-bis(2-hydroxyethyl)benzene, 2,2′-(o-phenylenedioxy)diethanol, resorcinol bis(2-hydroxyethyl) ether, hydroquinone bis(2-hydroxyethyl) ether, and bis(2-hydroxyethyl) terephthalate, and a cyclic diol component selected from one or more of cyclohexanedimethanol, cyclohexane diol, isosorbide, isomannide 4,4′-isopropylidenedicyclohexanol, tetramethyl cyclobutanediol, tricyclodecane dimethanol and spiroglycol wherein the molar ratio of isocyanate groups to alcohols (NCO Ratio) is from about 0.95 to 1.05, 0.97 to 1.03, 0.98 to 1.02 and the combined functionality of the isocyanates and alcohols is from 1.0 to 1.005, 1.005 to 1.02, or from 1.01 to 1.05.

In some embodiments, the diol component of the polyurethane is comprised of greater than 80 mole percent of cyclohexane dimethanol, 4,4′-isopropylidenedicyclohexanol, bis(2-hydroxyethyl) terephthalate and linear or branched diols having 9 or more carbon atoms, has a Tg of greater than 95° C., 100° C., 110° C., 115° C., 120° C., or 125° C. and a water uptake of less than 2%, 1.75%, 1.5%, 1.25%, or less than 1%.

In some embodiments, the TPU composition has a 24-hour shape recovery of greater than 50%, 55%, 60%, 65%, 70%, 75%, 80%, 85%, 90% or greater than 90%.

In some embodiments, the TPU composition has a force retention at 24 hours of greater than 500 grams (g), 600 g, 700 g, 750 g, 800 g, 900 g, 1,000 g, 1,100 g, 1,200 grams, 1,300 g, 1,400 g, 1,500 g, 1,600 g 1,700 g, 1800 g or greater than 1,800 g.

In some embodiments, the TPU composition has a mustard staining dB value of less than 20, 10, 5, or less than 3.

In some embodiments, the TPU composition has initial color in dB of less than 3, or less than 2, or less than 1

In some embodiments, the TPU composition has a water uptake after 48 hours at 60° C. of less than 2.20%, 2.10%, 2.00%, 1.90%, 1.80%, 1.75%, 1.70%, 1.65%, 1.60%, 1.55%, 1.50%, 1.45%, 1.40%, 1.35%, 1.30%, 1.25%, 1.20%, 1.15%, 1.10%, 1.05% or less than 1.00%.

In some embodiments, the TPU composition is substantially amorphous and has a single glass transition temperature of greater than about 85° C., 90° C., 95° C., 100° C., 105° C., 110° C., 115° C., 120° C., 125° C., or 130° C., when measured by DSC at 10° C. per minute.

In some embodiments, the TPU composition has a melting point of less than about less than about 240° C., 220° C., 200° C., or less than about 180° C., when measured by DSC at 10° C. per minute.

In some embodiments, the TPU composition has an elongation at break of greater than 50%, 55%, 60%, 65%, 70%, 75%, 80%, 85%, 90%, 95%, or 100%.

In some embodiments the TPU composition has an elongation at yield of greater than 5%, 6%, 7%, 8%, 9% or greater than 9%.

In some embodiments, the TPU composition has a flexural modulus of less than 2,500 MPa, e.g., from 350 MPa to 2,500 MPa PSI, from 500 MPa to 2,000 MPa, from 700 MPa to 2,000 MPa, from 1,000 MPa to 1,700 Mpa, or from 1,000 MPa to 1,500 Mpa.

In some embodiments, the TPU composition has an elastic modulus or tensile modulus of less than 2,500 MPa, from 350 MPa to 2,500 MPa, from 500 MPa to 2,000 MPa, from 700 MPa to 2,000 MPa, from 1,000 MPa to 1,700 Mpa, or 1,000 MPa to 1,500 Mpa.

In some embodiments, the TPU composition has a tensile strength of from 5,000 to 15,000 psi.

In some embodiments, the TPU composition has a haze value of less than about 20, 18, 16, 14, 12, 10, 8, 6, 4, or less than about 2 when tested using ASTM D1003.

In some embodiments, the TPU composition has a Shore hardness of from 80A to 85D.

In some embodiments, the resistance to stress cracking of a TPU composition is greater than 3.5 or greater than 4.

### Preparation of Thermoplastic Polyurethane (TPU) Compositions

The TPU composition may be prepared in a one-step (batch process), for example by extrusion or casting or may be prepared by step or sequential addition of isocyanate, diols and other components. The reaction may be promoted with catalysts and known stabilizers and process aids may be incorporated to improve stability or subsequent processing characteristics.

### Materials and Methods—Materials

Isoplast 2530 amorphous polyurethane Lubrizol Corporation.

Tritan MP 100 polyester Eastman Chemical.

Eastar 6763 polyester, Eastman Chemical.

Aliphatic and cycloaliphatic diols were obtained from Aldrich Chemical or other commercial vendors.

Polyisocyanates were obtained from Aldrich Chemical. MDI was 98% or greater purity and purified to remove dimer prior to use. H12MDI was 90% or greater purity without further purification.

Dimer fatty diol is a C36 diol available from Croda, Inc., New Castle, DE, under the trade designation PRIPOL 2033.

### Materials and Methods—Methods

Abrasion resistance is evaluated according to ASTM D4016-19p13 A using a 110mm round disc. A 0.030″ thick sample is pre-weighed to 0.1 mg and abrasion is tested with a 1000 g total load with an abrading wheel CS-17 for 1000 cycles at 70rpm using a Nextgen Taber Abrasion Machine. Abrasion is reported as weight loss in mg.

Dynamic mechanical analysis (DMA) testing is conducted on an instrument capable of applying a cyclical stress or strain on a material and measuring its response to specific conditions. Various ASTM methods are specified to standardize test procedures.

Elastic modulus (Young's Modulus and tensile modulus) (typically reported as Mega Pascal (MPa) is evaluated according to ASTM D638. Unless specified otherwise samples were tested using a type IV tensile bar and a speed of 1.27 cm/min.

Elongation at Break is evaluated according to ASTM D63—Unless specified otherwise samples were tested using type IV tensile bar and a speed of 1.27 cm/min.

Elongation at yield is evaluated according to ASTM D638—Unless specified otherwise samples were tested using type IV tensile bar and a speed of 1.27 cm/min.

Flexural modulus is evaluated according to ASTM D790.

Force retention (also referred to as stress retention), for example 5%, is measured using a three-point flexural bending test (with supports span of 0.60″) for a 0.030″ thick, 1.0″ wide, 2.0″ long sample, after a specified time-period. One may report either the force at a given time (for example 24 hours) or the percentage of initial force. Unless specified otherwise the test is conducted in water at a temperature of 37° C. with a strain of 5%.

Glass transition temperature and melting point are evaluated by Differential Scanning calorimetry (DSC) using a TA Instruments DSC at a heating rate of 10° C. per minute and reported for the second heating cycle.

Haze/clarity is evaluated according to ASTM D1003-13. A 0.030″ thick sample with both sides polished by pressing against optical quality-oriented PET film is measured using a Transmission Haze Meter (BYK Haze Guard).

Resistance to stress cracking is measured after tube wrap in mouth rinse by microscope inspection and visual rating of micro cracking, where “5” means no cracking and “1” means extensive cracking and erosion.

Shape Recovery is determined using a polymer strip measuring 101.75×25.4×0.76 mm (length, width, thickness) wrapped around a PVC pipe/tube (48.25 mm in diameter), clamped at the two ends, and immersed in 37° C. deionized (DI) water or mouth rinse at 25° C., for 24 hours. Recovery is measured at T=0 and 24 hours after tube wrap. The tube diameter is selected to impart 5% strain. At the end of the test period, the clamps are removed, and the strip is allowed to recover freely for 24 hours in air. The 24-hour shape recovery (%) is determined according to the following equation:

24-hour shape recovery (%)=100×(1−(((L−L24)/(L−L0)))
where L=full length of strip, 101.75 mm
L0=distance between opposite ends of clamped strip, 43.5 mm
L24=distance (mm) between opposite ends of free strip after 24-hour recovery

Shore Hardness is evaluated according to ASTM D 2240, using a durometer which measures the penetration of a metal foot or pin into the surface of a material, unless stated otherwise.

Stain resistance (reported as staining dB value) is the change in the dB value (using the CIE LAB color scale) of a 0.76 mm thick film sample after 24 hours exposure to mustard. The staining dB value is determined using a colorimeter and with the color evaluated on a white tile before and after mustard exposure. Unless stated otherwise, the sample is immersed in French's Classis Yellow Mustard (The French's Food Company, LLC) for 24 hours at 37° C. The color of the sample is measured before (as initial color in dB) and after (as final color in dB) staining process.

Staining dB value=final color in dB−initial color in dB

Tensile strength (the maximum stress a material can handle) is evaluated according to ASTM D638. Unless specified otherwise, samples were tested using type IV tensile bar and a speed of 1.27 cm/min.

Thermoforming open time is evaluated using a 125 mm×0.030″ thick sheet (dried to a moisture level of less than 0.05% w/w) that is placed on a wire rack at 20° C. and 50% relative humidity (RH). After varying time periods, the sample is placed on an IR thermoforming machine and rapidly heated to 200° C. for 60 seconds or until it sags 1 inch. The sample is considered to have failed if there are more than 5-bubbles larger than 0.5 mm. Results are reported as time to fail or pass/fail after a specified time period.

Water uptake is evaluated using a polymer sample having a thickness of 0.76 mm+/−0.1 mm that is first dried at 100° C. in a vacuum oven for 8 hours or longer and then placed in water at 60° C. for 48 hours, removed from the water, blotted dry and the weight gain of the sample is taken. Equilibrium moisture uptake=100×[(Weight Final−Weight Initial)/Weight Initial]. Preparation of polyurethanes.

Batch Process. Diols and additives are weighed into a vessel and optionally heated until melted. Polyisocyanate is added at once or stepwise into the vessel. Catalyst is added into the vessel if needed. The vessel is placed in a centrifugal mixer and mixed for 3 minutes or more until the entire mass is solidified. The vessel is then heated at a temperature of 120° C. for 12 hours to complete the reaction.

The cured sample is removed from the vessel and pressed at 400° F. to 450° F. to a thickness of approximately 2 mm and then compression molded to approximately 0.76 mm thick. Pressed samples were conditioned for 24 hours at ambient conditions before testing.

Stepwise Process. Polymer microstructure can be readily adjusted by altering the reaction process. A polyol may be initially reacted with an excess of polyisocyanate to create an isocyanate terminated oligomer which is then combined with diols and additional polyisocyanate. Alternatively, a first diol component is combined with a portion of the total isocyanate and allowed to react, followed by addition of a second diol component and optionally additional isocyanate to create a blocky microstructure.

The disclosure is further illustrated by the following examples. The examples are provided for illustrative purposes only. They are not to be construed as limiting the scope or content of the disclosure in any way.

### EXAMPLES

### Example 1

### Commercial Polyurethane Materials

Comparative Example 1 (CE1) Isoplast 2530 (Lubrizol) was extruded into a sheet 0.030″ thick. Isoplast 2530 is comprised of hexanediol and 4,4′-MDI and has a Tg of 81-89° C. (Table 2 of Isoplast Processing Guide; Lubrizol).

CE2: lsoplast 2531(Lubrizol) was molded into a sheet 0.030″ thick. lsoplast 2531 is comprised of hexanediol, cyclohexane dimethanol, poly tetramethylene oxide diol and 4,4′-MDI having a Tg of about 101-109° C. (Table 2 of lsoplast Processing Guide; Lubrizol).

CE3: Following the procedure of US 2018/0127535 A1 the material of Inv. Ex 1 was prepared by reacting a 2000 MW polycaprolactone diol with 1,9-nonadiol and 4,4′-MDI to prepare a polymer having approximately 34% soft block and 66% hard block.

CE4: the procedure provided in Example 1 of WO/2020/225651 was employed. A polymer was prepared comprised of MDI, hexane diol and 37% of a fatty acid based dimer alcohol diol.

### Experimental Polyurethane Materials.

Preparation of polyurethane.

Additional polyurethanes listed in Table 1 were prepared by a batch process and compression molded into plaques for evaluation.

TABLE 1
Experimental Polyurethane Compositions.

| | Property | | | | | |
|---|---|---|---|---|---|---|
| Component | EXP 1 | EXP 2 | EXP 3 | EXP 4 | EXP 5 | EXP 6 |
| 4,4′ MDI | 1.01 | 1.01 | 1.01 | 1.01 | 1.01 | 1.01 |
| 1,6 Hexane diol | 1 | | | | | 0.5 |
| 1,10 Decane diol | | | | 0.5 | | |
| 1,12 Dodecane diol | | 0.45 | 0.6 | | 0.55 | 0.25 |
| 1,4 Cyclohexane | | 0.55 | | 0.5 | | |
| dimethanol | | | | | | |
| Hydrogenated BPA | | | 0.4 | | | |
| Isosorbide | | | | | 0.45 | 0.25 |
| Moisture Uptake | 1.84% | 1.15% | 1.07% | 1.37% | 1.50% | 2.17% |
| (see Methods) | | | | | | |
| Shape Retention | 40% | 86% | 80% | 70% | 77% | 42% |
| (see Methods) | | | | | | |

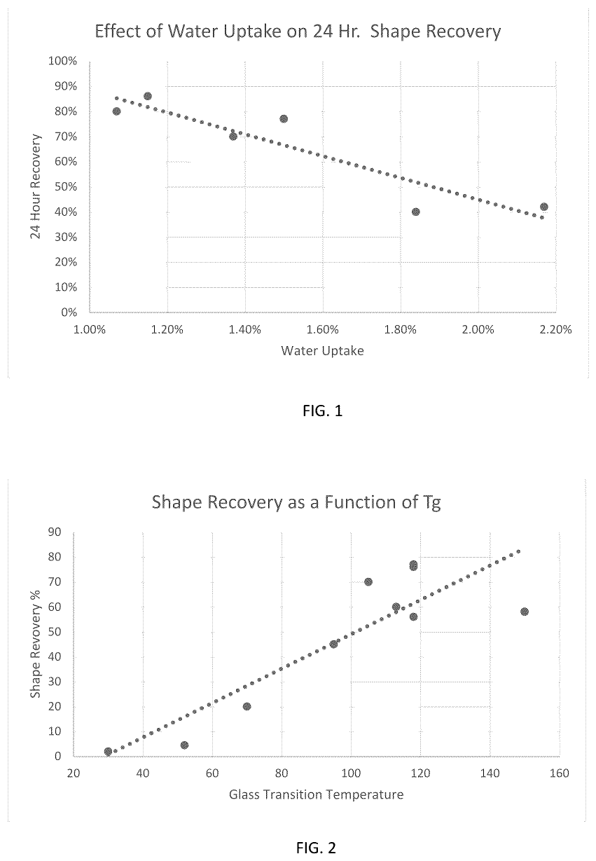

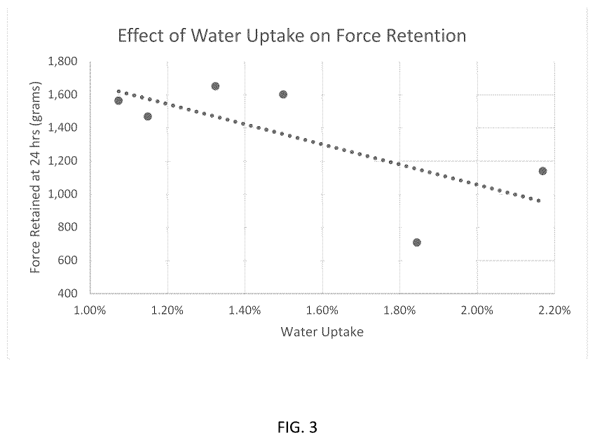

The relationship between equilibrium water uptake and shape recovery is further illustrated in FIG. 1.

As can be seen, lower equilibrium water uptake correlates with improved shape recovery. Materials with long chain diols (C10 and C12) perform better than C6 and partial replacement of C12 with C6 gives higher equilibrium water uptake and poorer shape recovery. The samples were also evaluated for force retention (5% strain, 3 point bend, in 37° C. water) with results shown in Table 2.

TABLE 2
Retained force at 5% strain after 24 hrs. in 37° C. water.

| | Equilibrium | | |
|---|---|---|---|
| Sample/ | water | | 24 hr. Force |
| Property | uptake % | Modulus (MPa) | (grams) |
| Exp 1 | 1.84% | 1,640 | 707 |
| Exp 2 | 1.15% | 1,757 | 1,467 |
| Exp 3 | 1.07% | 1,607 | 1,562 |
| Exp 4 | 1.32% | 1,480 | 1,650 |
| Exp 5 | 1.50% | 1,546 | 1,600 |
| Exp 6 | 2.17% | 1,598 | 1,138 |

Experimental samples 1 and 6, which contain hexane diol, have higher equilibrium water uptake and lower force retention even though they have high initial modulus values. EXP 2, 3, 4 and 5 each are comprised of dodecanediol and a cyclic diol which increases glass transition and improved stress retention. Addition of even 25 mol percent of the more hydrophilic hexane diol reduced the retained force from 1,600 grams to 1,138 grams.

Additional tests were conducted to investigate the effect of composition on glass transition temperature, shape recovery, stress retention, staining and other properties of interest.

TABLE 3a
Characterization of Experimental TPU Compositions.

| | | BM143- | BM143- | BM133- | BM143- | BM133- |
|---|---|---|---|---|---|---|
| | | 11-1 | 30-1 | 131-A1 | 20-2 | 95B |
| Material (Mol %) | CE1 | CE 3 | CE 4 | EX7 | EX8 | EX9 |
| Property | | | | | | |
| Polyisocyanate | MDI | MDI | MDI | MDI | MDI | MDI |
| (%)* | | | | | | |
| Diol 1 (Mol %) | 1,6 HDO | ND (92) | 1,6 HD (64) | DDDO (100) | CHDM (100) | DDO (50) |
| Diol 2 (Mol %) | | | | | | CDHM (50) |
| Polyol | | PCL 2,000 (8) | Pripol (36) | | | |
| Tg C (TM) | 95 | 30 (Tm = | 52 (Tm = | 65 | 150 | 105 |
| | | 127, 145) | 142) | | | |
| Modulus (MPa) | 1640 | 25.9 | 1263 | 1371 | 1838 | 1480 |
| Elongation @ | 136 | 208 | 169 | 172 | 37 | 97 |
| Break (%) | | | | | | |
| Elongation @ | 6 | NA | 4.7 | 6.4 | 8 | 6.9 |
| Yield | | | | | | |
| 24 hr. Recovery | 45 | 2 | 4.5 | 5.9 | 58 | 70 |
| (%) | | | | | | |
| 24 hr. Stress | 707 | <500 | <500 | 835 | Crack | 1483 |
| Retention (grams) | | | | | | |
| Staining dB value | 0.97 | 47 | 7 | NM | 0.6 | 1 |

*Molar ratio of NCO to OH = 0.98 to 1.02 unless noted otherwise
BD = 1,4-Butanediol, NDO = 1,9-Nonadiol, DDO = 1,10-Decane Diol, DDDO = 1,12-Dodecane Diol, HDO = 1,6-Hexane Diol, PCL 2,000 = Polycaprolactone MW 2,000, Pripol = Pripol 2033, CRODA, CHDM = Cyclohexane Dimethanol, HPA = Hydrogenated Bis Phenol A, UH 200 = Enteracoll Aliphatic Polycarbonate, MW 2,000 UBE

TABLE 3b
Characterization of Experimental TPU Compositions.

| | BM133- | BM133- | BM143- | BM133- | BM133- | BM133- |
|---|---|---|---|---|---|---|
| | 134-A | 135-B | 34-1 | 102B | 108G | 101-D |
| Material (Mol %) | EX10 | EX11 | EX12 | EX13 | EX14 | EX 15 |
| Property | | | | | | |
| Polyisocyanate | MDI | MDI | MDI | MDI | MDI | MDI |
| (%)* | | | | | | |
| Diol 1 (Mol %) | DDDO (50) | DDDO (30) | DDDO (20) | DDDO (60) | DDDO (55) | DDDO (30) |
| Diol 2 (Mol %) | CHDM (50) | CHDM (70) | CHDM (80) | HBPA (40) | Iso (45) | BD (37) |
| Diol 3 (Mol %) | | | | | | CHDM (30) |
| Polyol | | | | | | UH200 (3) |
| Tg C (TM) | 102 | 118 | 126 | 113 | 118 | 71 |
| Elastic Modulus, | 1,565 | 1,619 | 1,714 | 1,561 | 1546 | 1724 |
| MPa | | | | | | |
| Elongation @ | 103 | 72 | 59 | 98 | 59 | 95 |
| Break (%) | | | | | | |
| Elongation @ | 6 | 7.3 | 7.4 | 6.4 | 7.4 | 4.8 |
| Yield (%) | | | | | | |
| 24 hr. shape | 30 | 56 | 59 | 60 | 77 | 20 |
| recovery (%) | | | | | | |
| 24 hr. force | >900 | >1200 | 1540 | 1562 | 1600 | <500 |
| retention (g) | | | | | | |
| Staining dB value | 0.7 | NM | 0 | 0 | NM | 3.8 |

NM = not measured

These tests show that polyurethane compositions consisting of MDI and 1,6-hexanediol have poor stress retention, which is believed to be due at least in part to high equilibrium water uptake. Prior art example CE3, containing longer chain diol (C9), and a polyester soft block has very poor shape recovery and quite low stress retention. This may be due to the low glass transition temperature and low modulus of the polyester. Likewise, prior art example CE4, comprising hexanediol hard blocks and dimer acid based diol soft blocks has poor shape recovery, stress retention and also stains badly.

EX 7, consisting of just dodecanediol and MDI has a low Tg, poor shape recovery and low stress retention.

EX 8, comprised of just CHDM and MDI has a higher than desired modulus and Tg and has very low elongation at break, making it not useful as a material for use in making dental appliances. The materials of EX 9, 10, 11, 12, 13 and 14 are comprised of a long chain diol and a cyclic diol which increases Tg and gives a surprising combination of excellent shape recovery, stress retention and low staining.

Of particular note is that samples EX 8, 9, 11, and 12, which utilize a combination of long chain diol and cyclohexane dimethanol have elongation to yield values above 6% and as high as 8% which is unexpected and very desirable. The reason for this high value is not known. Additionally, sample EX 14 consisting of dodecanediol and isosorbide measures 7.4% elongation at yield, very high for a rigid polyurethane. CE 3, CE 4 and EX 15 which contain soft domains on the other hand surprisingly either exhibit no distinct yield point or a low yield point.

FIG. 2 shows the relationship between glass transition temperature and shape recovery for these materials. Materials disclosed herein having Tg values greater than 100 C perform better than materials with lower values.

TABLE 3c
Characterization of Experimental TPU Compositions.

| | EX 16 | EX 17 | EX 18 | EX 19 | EX 20 | EX 21 |
|---|---|---|---|---|---|---|
| | BM143-116-1 | BM143-119-1 | BM143-130-1 | BM143-143-1 | BM143-134-3 | BM143-139-1 |
| Composition (1) | MDI/CHDM/C12/ | MDI/CHDM/C12/ | MDI/TMC/C12 | MDI/CHDM/HHEE/ | MDI/BHET/C12 | MDI/CHDM/BHET/ |
| | ISO/PTHF/PCT | ISO/PTHF/PCT | | C12/TMP | | C12/TMP |
| Molar Ratio | 105/45/35/10/10/3 | 105/51.7/35/10/3.3/3 | 100/40/60 | 103/50/15/35/3 | 100/55/45 | 103/20/50/30/3 |
| Tg, C | 83 | 91 | 104 | 110 | 95 | 107 |
| Elongation @ Yield (%) | 5.1 | 5.3 | 6.1 | 6.7 | 5.8 | 5.9 |
| Elongation @ Break (%) | 113 | 120 | 76 | 83 | 135 | 100 |
| Elastic Modulus, Mpa | 1428 | 1363 | 1416 | 1513 | 1475 | 1676 |
| 24 hr. shape recovery (%) | 23 | 27 | 47 | 60 | 32 | 48 |
| Staining dB value | 3.7 | 8.4 | 0.8 | 0.7 | 0.7 | 0.8 |

1 PTHF = polytetrahydrofuran, PCT = polycaprolactone triol, TMC = 2,2,4,4-tetramethylcyclobutane-1,3-diol, HHEE = hydroquinone bis(2-hydroxyethyl)ether, BHET = bis(2-hydroxyethyl) terephthalate

The introduction of a flexible polyol such as PTHF can help to improve elongation at break to over 100%. This is accompanied with the increase in staining dB value, as shown in EX 17 and 18. Of particular interest, TPUs with bis(2-hydroxyethyl) terephthalate possess high elongation at break percentage with very low staining dB value as shown in EX 20 and 21.

TABLE 3d
Characterization of Experimental TPU Compositions.

| | EX 22 | EX 23 | EX 24 | EX 25 |
|---|---|---|---|---|
| | BM143-72-2 | BM143-78-1 | BM143-78-2 | BM143-96-1 |
| Composition | H12MDI/CHDM | H12MDI/CHDM/ | H12MDI/CHDM/ | H12MDI/trans- |
| | | C12 | C12 | CHDM/C12 |
| Molar Ratio | 100-100 | 100-70-30 | 100-75-25 | 100-70-30 |
| Tg, C | 135 | 108 | 114 | 109 |
| Elongation @ Yield (%) | 9.5 | 8.0 | 8.6 | 8.1 |
| Elongation @ Break (%) | 35 | 71 | 66 | 82 |
| Elastic Modulus, Mpa | 1557 | 1365 | 1348 | 1367 |
| 24 hr. shape recovery (%) | 75 | 85 | 87 | 84 |
| 24 hr. force retention (g) | 1704 | 1733 | 1781 | 1884 |
| Staining dB value | 1.3 | 2.2 | 1.7 | 2.6 |
| Initial color in dB | 0.8 | 0.6 | 0.5 | 0.7 |

Further modification of properties can be realized via replacing MDI with H12MDl as diisocyanate monomer to provide slightly “softer” TPUs. As shown in the table above, with slightly higher in staining dB value, EX 22 to 25 offer lower Elastic Modulus, much improved Elongation at Yield, elastic recovery and force retention. Particularly, EX 22 has Elongation at Yield measured of 9.5%; EX 23 and 24 have 24 hr. shape recovery measured over 85%; and EX 25 has 24 hr. force retention measured over 1880 g. Meanwhile, with the introduction of more flexible H12MDI monomer, TPU materials also provide advantages for high temperature processing in less yellowing and higher flow.

Preparation of TPU with blocky structure. A polyurethane was prepared having a final molar composition ratio of 1.02 MDI, 0.45 C12 diol and 0.55 CHDM. Dodecanediol (45 mole%) and CHDM (10 mole %) were combined and melted, then 102 mole % MDI was added, and reaction allowed to proceed with mixing, followed by addition of 45 mole % CHDM.

Polyurethanes with branching. Polyurethanes were prepared and characterized as shown in Table 3e.

TABLE 3e
Characterization of Experimental TPU Compositions.

| | EX 26 | EX 27 | EX 28 | EX 29 | EX 30 | EX 31 |
|---|---|---|---|---|---|---|
| | BM133- | BM133- | BM133- | BM133- | BM133- | BM133- |
| | 134-G | 134-H | 134-I | 137-B | 137-A | 138-C |
| Composition (1) | MDI/Tricyco/ | MDI/Tricyco/ | MDI/Tricyco/ | MDI/C12/ | MDI/C12/ | MDI/C12/ |
| | C12 | C12. DEA | C12 - TMP | CHDM | CHDM/TMP | CHDM/TMP |
| | | | | | | 103-45-55-3 |
| Molar | 102-50-50 | 100-45- | 100-45- | 103-45-55 | 103-45- | 103-45-55-2 |
| Ratio | | 55-1.3 | 55-1.3 | | 55-1.3 | |
| Tg, C | 108 | 112 | 117 | | 108 | 110 |
| Elongation | 6.18 | 6.11 | 6.47 | 6.52 | 6.35 | 6.6 |
| @ Yield (%) | | | | | | |
| Elongation | 99.47 | 82.09 | 107.43 | 70.0 | 67.25 | 99.09 |
| @ Break (%) | | | | | | |
| Elastic | 1,555 | 1,685 | 1,714 | 1,586 | 1,477 | 1475 |
| Modulus, | | | | | | |
| MPa | | | | | | |
| 24 hr. shape | 50.76 | 51.19 | 61.04 | 47 | 59.25 | 68.54 |
| recovery (%) | | | | | | |
| 24 hr. force | <1000 | TBD | 1,436 | 1,192 | 1,274 | 1,533 |
| retention (g) | | | | | | |

(1) Tricyclo = 4,8-bis(hydroxymethyl)tricyclo-[5.2.1.0^{2,6}]decane, C12 = dodecane diol, CHDM = cyclohexanedimethanol, DEA = diethanol amine, TMP = trimetholyl propane

These examples show that a small fraction of multifunctional monomer increases the shape recovery and force retention while not impairing thermoplastic processing and does significantly affect the modulus. The material of example 31 has almost 50% more force retention at 24 hours than example 29.

TABLE 3f
Characterization of Experimental TPU Compositions.

| | EX 32 | EX 33 | EX 34 | EX 35 |
|---|---|---|---|---|
| | BM143-128-2 | BM143-128-3 | BM143-128-4 | BM143-135-1 |
| Composition (1) | HMDI/CHDM/ | HMDI/CHDM/ | HMDI/CHDM/ | HMDI/CHDM/ |
| | C12/TMP | C12/PCT | C12/THB | C12/p-GP430 |
| Molar Ratio | 105/70/30/3 | 105/70/30/3 | 105/70/30/3 | 105/70/30/3 |
| Tg, C | 111 | 110 | 112 | 110 |
| Elongation @ Yield (%) | 8.3 | 8.2 | 8.3 | 8.1 |
| Elongation @ Break (%) | 66 | 69 | 61 | 70 |
| Elastic Modulus, Mpa | 1280 | 1314 | 1305 | 1343 |
| 24 hr. shape recovery (%) | 73 | 73 | 76 | 67 |
| 24 hr. force retention (g) | 1510 | 1197 | 1354 | 1205 |
| Staining dB value | 1.6 | 1.8 | 1.7 | 1.6 |
| Initial color in dB | 0.7 | 0.7 | 0.9 | 1.0 |
| Rating for chemical | 5 | 5 | 5 | 5 |
| resistance under stress | | | | |

1 THB = 1,3,5-tris(hydroxylmethyl)benzene, p-GP430 = PLURACOL GP430 Polyol (BASF)

Table 3f show some H12MDI based TPU examples prepared with small fraction of tri-functional monomers acting as crosslinker. These materials possess excellent chemical resistance under stress towards various media such as mouth rinse with rating of 5, compared to rating of 3 for EX 23, which does not have tri-functional monomers.

The material of EX 13 is used as the A layer in an ABA three layer sheet where in the B layer is an aromatic polyether polyurethane of Shore 50D having excellent interlayer adhesion, high tear strength and excellent stress retention.

When sheet materials of EX 7 to EX 15 are thermoformed over dental models, they can be used to make appliances for positioning teeth.

Minor amounts of polyols, especially polytetramethylene glycol having MW of 650 to 5,000 were incorporated to produce phase separated polymers (as judged by DSC) to improve impact resistance, lower modulus, and increase tear strength. Preferably the amount is less than about 7.5, 5, 2.5% by weight.

Although specific embodiments of the disclosure have been described, various modifications, combinations, alterations, alternative constructions, and equivalents are also encompassed within the scope of the disclosure. Embodiments of the present disclosure are not restricted to specific methods for making TPU compositions, but may employ any methods for making TPU compositions known to those of skill in the art. Additionally, although embodiments of the present disclosure have been described using a particular series of transactions and steps, it should be apparent to those skilled in the art that the scope of the present disclosure is not limited to the described series of transactions and steps.

The specification and drawings are, accordingly, to be regarded in an illustrative rather than a restrictive sense. It will, however, be evident that additions, subtractions, deletions, and other modifications and changes may be made thereunto without departing from the broader spirit and scope.

1. A thermoplastic polyurethane (TPU) reaction mixture, comprising:
a diol component and a diisocyanate component wherein the diol component comprises at least one linear aliphatic diol having the general formulas HO—(CH₂)ₓ-OH wherein x is an integer from 9 to 18 and one or more cyclic diols having 6 or more carbons, or one or more aromatic diols, wherein the molar ratio of isocyanate groups to alcohols (NCO Ratio) is from about 0.95 to 1.05, and the reaction mixture comprises less than 20% of a polymeric diol component having a glass transition temperature of less than 0° C.

2. The TPU reaction mixture according to claim 1, wherein the diisocyanate component comprises one or more of MDI, TDI, PDI, HDI, H12MDI, IPDI, XDI, CHDI, or HXDI.

3. The TPU reaction mixture according to claim 2, wherein the diisocyanate component comprises greater than 50%, 55%, 60%, 65%, 70%, 75%, 80%, 85%, or 88% MDI.

4. The TPU reaction mixture according to claim 2, wherein the diisocyanate component comprises greater than 50%, 55%, 60%, 65%, 70%, 75%, 80%, 85%, or 88% H12MDI.

5. The TPU reaction mixture according to claim 1, wherein the diol component comprises greater than 80 mole percent of cyclohexane dimethanol, 4,4′-isopropylidenedicyclohexanol, bis(2-hydroxyethyl) terephthalate and linear or branched diols having 9 or more carbon atoms.

6. The TPU reaction mixture according to claim 1, wherein the aliphatic diol component comprises one or more of 1,9-nonanediol, 1,10-decanediol, 1,11-undecanediol, 1,12-dodecanediol, 1,14-tetradecanediol, 1,16-hexadecanediol, and 1,18-octadecanediol.

7. The TPU reaction mixture according to claim 1, wherein the cyclic diol component comprises one or more of cyclohexane dimethanol, tetramethylcyclobutanediol, hydrogenated bisphenol A, cyclohexane diol, and isosorbide.

8. The TPU reaction mixture according to claim 1, wherein the aromatic diol component comprises one or more of 1,2-benzenedimethanol, 1,3-benzenedimethanol, 1,4-benzenedimethanol, 1,4-bis(2-hydroxyisopropyl)benzene, 1,4-bis(2-hydroxyethyl)benzene, 2,2′-(o-phenylenedioxy)diethanol, resorcinol bis(2-hydroxyethyl) ether, hydroquinone bis(2-hydroxyethyl) ether, and bis(2-hydroxyethyl) terephthalate.

9. (canceled)

10. (canceled)

11. (canceled)

12. A TPU composition prepared with a reaction mixture according to claim 1, wherein the polymer is blended with one or more other polymers.

13. A TPU composition prepared with a reaction mixture according to claim 1, wherein the polymer is substantially amorphous, and has a glass transition temperature of greater than 85° C., and less than 150° C.

14. A TPU composition prepared with a reaction mixture according to claim 1, wherein the polymer is substantially amorphous and has a glass transition temperature of greater than 100° C. or greater than 110° C., and less than 150° C.

15. A TPU composition prepared with a reaction mixture according to claim 1, having a stress retention of greater than 500 grams or greater than 750 grams, and less than 2500 grams or less than 3000 grams.

16. A TPU composition prepared with a reaction mixture according to claim 1, having a water uptake of less than 1.80% or less than 2.20%, and greater than 0.40% after 48 hours at 60° C.

17. A TPU composition prepared with a reaction mixture according to claim 1, having an elongation at yield of greater than 6%, and less than 12%.

18. (canceled)

19. (canceled)

20. A TPU composition prepared with a reaction mixture according to claim 1, having an elongation at break of greater than 55% or greater than 75% or greater than 95%, and less than 200%.

21. (canceled)

22. (canceled)

23. A TPU composition prepared with a reaction mixture according to claim 1, having a flexural modulus of from 500 MPa to 2,500 MPa.

24. A TPU composition prepared with a reaction mixture according to claim 1, having an elastic or tensile modulus of from 500 Mpa to 2,500 Mpa.

25. (canceled)

26. (canceled)

27. (canceled)

28. A polymeric sheet composition, comprising a TPU composition prepared with a reaction mixture according to claim 1.

29. A multilayer TPU laminate comprising a TPU composition prepared with a reaction mixture according to claim 1.

30. A reversibly deformable dental appliance conformal to one or more teeth comprising a polymeric sheet composition according to claim 28.

31. A reversibly deformable dental appliance conformal to one or more teeth comprising a multilayer TPU laminate according to claim 29.
